(19) United States
(12) Patent Application Publication
(10) Pub. No.: US 2013/0150090 A1
(43) Pub. Date: Jun. 13, 2013

(54) APPARATUS AND METHOD FOR PROVIDING LOCATION-BASED SERVICE

(71) Applicants: Young-Su CHO, Seoul (KR); Myung-In JI, Daejeon (KR); Sang-Joon PARK, Daejeon (KR)

(72) Inventors: Young-Su CHO, Seoul (KR); Myung-In JI, Daejeon (KR); Sang-Joon PARK, Daejeon (KR)

(73) Assignee: Electronics and Telecommunications Research Institute, Daejeon (KR)

(21) Appl. No.: 13/612,421

(22) Filed: Sep. 12, 2012

(30) Foreign Application Priority Data
Dec. 9, 2011 (KR) 10-2011-0131821

(51) Int. Cl. G06Q 20/32; H04W 4/02

(52) U.S. Cl. 455/456.3

(57) ABSTRACT

Disclosed herein are an apparatus and method for providing a location-based service. The apparatus includes a location-based service server and a wireless communication infrastructure location DB. When a mobile payment service is performed for a member store terminal using a user mobile terminal, the location-based service server receives measurement information about a wireless communication infrastructure and information about the location of the member store from the mobile terminal, and generates information about the location of the wireless communication infrastructure using the received measurement information about the wireless communication infrastructure and the information about the location of the member store. The wireless communication infrastructure location DB stores the generated information about the location of the wireless communication infrastructure.

### CROSS REFERENCE TO RELATED APPLICATION

This application claims the benefit of Korean Patent Application No. 10-2011-0131821, filed on Dec. 9, 2011, which is hereby incorporated by reference in its entirety into this application.

### BACKGROUND OF THE INVENTION

1. Technical Field

The present invention relates generally to an apparatus and method of providing a location-based service. More particularly, the present invention relates to a method which generates a location Database (DB) for wireless communication infrastructures and also provides a payment location information-based service using payment location information and measurement information about the wireless communication infrastructures, which are provided when a mobile payment service is provided using user terminals.

2. Description of the Related Art

A Global Positioning System (GPS)-based location determination technology (LDT) is capable of, using GPS satellites, providing information about the locations of user terminals equipped with GPS receivers via a world coordinate system (for example, latitude, longitude, and elevation) with an accuracy corresponding to the level of a few meters to tens of meters in outdoor spaces throughout the Earth. In the future, with the advent of an additional Global Navigation Satellite System (GNSS), such as Europe's Galileo or Russia's Glonass, it is predicted that the availability and accuracy of location determination will be improved in outdoor spaces. However, in indoor spaces or in densely-populated downtown areas, weak signals are received and multipath errors frequently occur because of the obstruction of buildings, so that it may be impossible to determine a location or the accuracy of location determination may be deteriorated.

A mobile communication base station-based location determination technology has the advantage of enabling an initial location determination time to be comparatively shorter than that of the GPS, but has the disadvantage of having location accuracy which is generally lower than that of the GPS.

A Wireless-Fidelity (Wi-Fi)-based location determination technology enables accurate location information to be provided at the level of a few meters using the strength of signals from Wi-Fi Access Points (APs) in buildings or densely-populated downtown areas where GPS signals are not received or GPS location errors are great. Recently, the service available area of the Wi-Fi-based location determination technology has been expanded to metropolitan areas using Wardriving or AP mapping technology by America's Skyhook Wireless company, etc. However, the Wardriving technology using vehicles has the problem of incurring great initial expense in order to construct a location DB for Wi-Fi APs.

Smart phones whose popularization is increasing recently are equipped with Wi-Fi chips as well as 3rd-Generation (3G) mobile communication chips, so that they can perform location recognition based on each of a GPS, a Wi-Fi system and a cellular system, and perform complex location recognition based on combinations thereof. Furthermore, when the development of a mobile communication network (for example, an LTE or WiMAX network) and the support of a local area communication (for example, Near Field Communication (NFC)) function in the future is taken into consideration, the availability and accuracy of terminal location determination can be improved based on the location determination technology using multiple infrastructures.

U.S. Patent Application Publication No. 2010-0157848 discloses a technology for obtaining a local map and information required for the determination of locations based on measurement information about wireless communication infrastructures received from mobile terminals.

However, in order to apply the multiple infrastructure-based location determination technology to terminals, a method of effectively constructing a location DB for the multiple infrastructures of the mobile communication service areas throughout the country or the world is required.

In order to construct a highly precise heterogeneous infrastructure location DB in a wide area environment throughout the country or the world, there is required a mobile service-connected collection technology which enables measurement information, stored in a location DB for peripheral infrastructures, to be provided while collected locations are provided as accurately as possible.

Meanwhile, when the trend of the recent hardware development of mobile terminals in which NFC modules have been added and the trend of the activation in a mobile payment market in which mobile communication companies have established strategic alliances with credit card companies is taken into consideration, it is predicted that a mobile payment service will grow into a killer application in a mobile service market in the future.

In particular, in the mobile payment service, when a user requests use of a mobile coupon or a mobile payment, a reference location can be automatically found using the name of a store, the name of the representative of the store, and the address, business registration number and telephone number of the store which are included in the DB of the member store, and information which is required for the construction of a heterogeneous infrastructure location DB can be collected by combining the reference information, which is obtained as described above, with measurement information about infrastructures, such as Wi-Fi, Wideband Code Division Multiple Access (WCDMA), Wireless Broadband (WiBro), Radio-Frequency Identification (RFID), ZigBee, NFC, and Bluetooth infrastructures, which is obtained when payments are made.

### SUMMARY OF THE INVENTION

Accordingly, the present invention has been made keeping in mind the above problems occurring in the prior art, and an object of the present invention is to provide a method of collecting the reference locations of the users of mobile terminals and measurement information about infrastructures by using a mobile payment service.

Another object of the present invention is to provide a method of constructing an infrastructure location DB based on the information collected as described above and providing a location-based service based on payment locations.

In order to accomplish the above object, the present invention provides An apparatus for providing a location-based service, including a location-based service server for, when a mobile payment service is performed for a member store terminal using a mobile terminal which receives information about a location of a member store from the member store terminal or a member store DB and which also receives measurement information about a wireless communication infrastructure from the wireless communication infrastructure, receiving the measurement information about the wireless communication infrastructure and the information about the location of the member store from the mobile terminal, and generating information about a location of the wireless communication infrastructure using the received measurement information about the wireless communication infrastructure and the information about the location of the member store; and a wireless communication infrastructure location DB for storing the generated information about the location of the wireless communication infrastructure.

The location-based service server may receive the measurement information about the wireless communication infrastructure and the information about the location of the member store from the mobile terminal via a DB and payment server of a mobile payment company.

The DB and payment server of the mobile payment company may communicate with a server of a credit card company, a debit card company, a communication company, a gift card company, or a bonus point company.

The information about the location of the member store may include member store Identification (ID) information or member store object ID information stored in the DB of the member store.

If the information about the location of the member store is not sufficiently accurate to be used to estimate the information about the location of the wireless communication infrastructure, the location-based service server may receive the member store ID information or the member store object ID information from the user mobile terminal.

The apparatus may further include a map DB; wherein the location-based service server calculates the information about the location of the member store by comparing the member store ID information or the member store object ID information with information stored in the map DB.

In order to accomplish the above object, the present invention provides a method of providing a location-based service using a location-based service providing apparatus when a mobile payment service is performed for a member store terminal using a mobile terminal for receiving information about a location of a member store from the member store terminal or a DB of the member store and receiving measurement information about a wireless communication infrastructure from the wireless communication infrastructure, the method comprising: receiving the measurement information about the wireless communication infrastructure and the information about the location of the member store from the mobile terminal; generating information about a location of the wireless communication infrastructure using the received measurement information about the wireless communication infrastructure and the information about the location of the member store; and storing the generated information about the location of the wireless communication infrastructure in a wireless communication infrastructure location DB.

The receiving the information about the location of the member store may include receiving the measurement information about the wireless communication infrastructure and the information about the location of the member store from the mobile terminal via a DB and payment server of a mobile payment company.

The DB and payment server of the mobile payment company may communicate with a server of a credit card company, a debit card company, a communication company, a gift card company, or a bonus point company.

The information about the location of the member store may include member store ID information or member store object ID information stored in the DB of the member store.

The method may further include, when the information about the location of the member store is not sufficiently accurate to be used to estimate the location information of the wireless communication infrastructure, receiving the member store ID information or the member store object ID information from the user mobile terminal.

The method may further include providing a map DB; and calculating the information about the location of the member store by comparing the member store ID information or the member store object ID information with information stored in the map DB.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram illustrating the collection of information for a location DB for mobile payment service-based infrastructures according to embodiments of the present invention;

FIG. 2 is a block diagram illustrating a system for constructing a location DB for mobile payment service-based infrastructures and providing a location-based service according to a first embodiment of the present invention;

FIG. 3 is a block diagram illustrating a system for constructing a location DB for mobile payment service-based infrastructures and providing a location-based service according to a second embodiment of the present invention;

FIG. 4 is a flowchart illustrating a method of constructing a mobile payment service-based location DB and providing payment location-based information according to embodiments of the present invention;

FIG. 5 is a flowchart illustrating a method of obtaining a mobile payment service-based payment location according to embodiments of the present invention;

FIG. 6 is a diagram illustrating the procedure of the method of constructing a location DB for mobile payment service-based infrastructures and providing a location-based service in the case where the credit card company server of the first embodiment is involved;

FIG. 7 is a diagram illustrating the procedure of the method of constructing a location DB for mobile payment service-based infrastructures and providing a location-based service in the case where the communication company/gift card company/bonus point company server of the first embodiment is involved; and

FIG. 8 is a diagram illustrating the procedure of the method of constructing a location DB for mobile payment service-based infrastructures and providing a location-based service according to a third embodiment.

### DESCRIPTION OF THE PREFERRED EMBODIMENTS

The present invention will be described in detail with reference to the accompanying drawings below. Here, repetitive descriptions, and detailed descriptions of well-known functions or configurations which would unnecessarily obscure the gist of the present invention will be omitted. Embodiments of the present invention are provided to complete the explanation for those skilled in the art of the present invention. Therefore, the shapes and sizes of components in the drawings may be exaggerated to provide more precise descriptions.

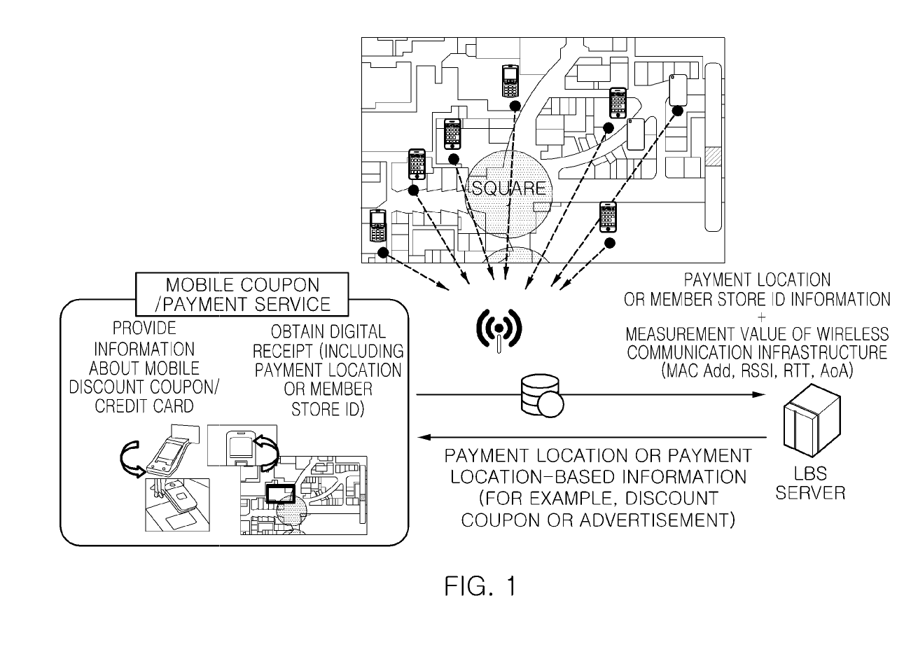

FIG. 1 is a conceptual diagram illustrating the collection of information for a location DB for mobile payment service-based infrastructures according to embodiments of the present invention. A procedure for collecting information for a location DB is divided into a location DB information collection procedure in an off-line Value-Added Network (VAN) environment and a location DB information collection procedure in an on-line VAN environment.

First, the location DB information collection procedure in an off-line VAN environment will now be described.

The user of a mobile terminal who visits a member store finds one or more desired products and goes to a counter. At the counter, information about the products (the price of the products and the number of products) is input using a barcode, Radio Frequency Identification (RFID) device or Near Field Communication (NFC) device, and then the total purchase amount is calculated.

Thereafter, the user who wants to use a mobile discount coupon or to make a payment for the products executes a mobile payment application, connects with a terminal of the member store via a wired or wireless connection, transmits information about the discount coupon and a credit card, and requests a payment.

The terminal of the member store which has received the payment request, while operating in conjunction with the server of a mobile payment company and the server of a credit card company, requests approval for a transaction and receives a response. The terminal of the member store which has received the response provides a digital receipt to the mobile terminal. Here, the provided digital receipt includes the location of the member store (that is, a payment location). If the DB of the member store does not include the location of the member store or required accuracy is not fulfilled, member store ID information or member store object ID information, such as the name of the member store, the name of the representative of the member store, or the address, business registration number or unique number, or telephone number of the member store, which is stored in the DB of the member store or the object DB of the member store is transferred to a Location-Based Service (LBS) server, and is then compared with information stored in a map DB, thereby obtaining the payment location.

Finally, the payment location (in the case where the payment location can be provided based on the DB of the member store or the object DB of the member store) or the member store information or the member store ID information (in the case where the payment location cannot be provided based on the DB of the member store or the object DB of the member store) which is used to construct a location DB for mobile payment-based wireless communication infrastructures is provided to the LBS server along with measurement information about the wireless communication infrastructure. The LBS server which has received the above information uses the information to construct the location DB for wireless communication infrastructures. If the mobile terminal user requests a payment location-based service (for example, use of a discount coupon, or an advertisement), the LBS server provides the corresponding payment location-based service together with the payment location.

Here, the member store ID information or the member store object ID information refers to unique identification information of the member store or equipment in the member store, and may include, for example, the name of the member store, the name of the equipment in the member store, the name of the representative of the member store, or the address, business registration number or unique number, or telephone number of the member store.

Furthermore, the payment location refers to a location where a payment is made, and can be represented using absolute coordinates (for example, latitude/longitude/elevation), relative coordinates (for example, reference point-based relative locations X, Y, and Z), or an address system (for example, entrance jjj of No. iii, gg-th story of fff building, in ccc-Ro, bbb-Dong, aaa-Gu, Seoul).

Meanwhile, the location DB information collection procedure in an on-line VAN environment will now be described.

The user of a mobile terminal who visits a member store finds one or more desired products and then goes to a counter. At the counter, information about the products (the price of the products or the number of products) is received using a barcode, RFID or NFC device, and then the total purchase amount is calculated.

Thereafter, the user who wants to use a mobile discount coupon or to make a payment executes a mobile payment application, connects with the terminal of the member store via a wired or wireless connection, and transmits information about an order. A member store application which has received the information about the order transmits the information about the order to the DB and server of the member store, and then receives the location information or ID information of the member store from the DB of the member store.

Thereafter, the member store application registers transaction authentication with the mobile payment application, and, while operating in conjunction with the server of the member store, the DB and payment server of a mobile payment company and the server of a credit card company, requests a credit card company to perform authentication and approval for payment, and receives a response. The DB and payment server of the mobile payment company which have received the results of the approval, while operating in conjunction with the LBS server, transmits the payment location (or the member store ID information) and the measurement information about the wireless communication infrastructure, and receives payment location-based information.

Finally, the DB and payment server of the mobile payment company provides the results of the approval and the payment location (or the payment location-based information) to the user of the mobile terminal

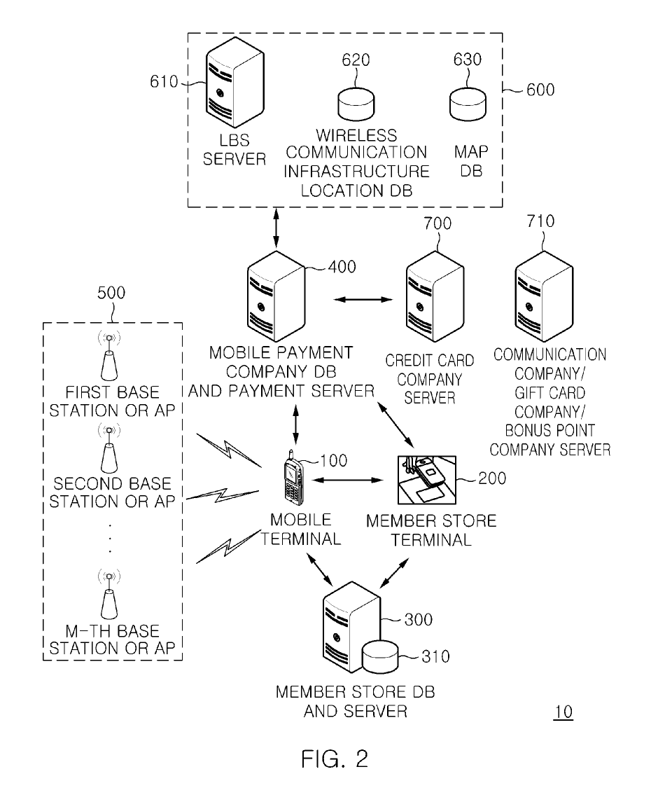

FIG. 2 is a block diagram illustrating a system 10 for constructing a location DB for mobile payment service-based infrastructures and providing a location-based service according to a first embodiment of the present invention. In the first embodiment, measurement information about wireless infrastructures which is used to constructs a wireless communication infrastructure location DB 620 is collected via the DB and payment server 400 of a mobile payment company, and payment location-based information (for example, use of a discount coupon or an advertisement) is provided.

A mobile terminal 100 is a terminal which includes hardware which is capable of executing a member store application and a mobile payment application and performing data communication with a member store terminal 200, a member store server 300, a member store DB 310, a mobile payment company DB and payment server 400, and a peripheral wireless communication infrastructure 500 via a wired or wireless connection.

The member store terminal 200 includes a device which receives information about a product and a price using a barcode, RFID or NFC technology, a device which displays the information about the product and the price, and a communication device which provides the information about the product and the price (hereinafter referred to as product order information) to the mobile terminal 100.

The member store DB 310 is a DB which stores information about the details of a member store or a member store object (a name, the name of a representative, an address, a business registration number or a unique number, and a telephone number), and the member store server 300 is an operation unit which manages the corresponding member store DB. The member store DB 310 and the member store server 300 communicate with the member store application or the mobile payment application, which is installed in the member store terminal 200 or the mobile terminal 100, and provide information about the details of the member store and the product.

The mobile payment company DB and payment server 400 is a server which receives a request for payment information from the mobile terminal 100 or the member store terminal 200, which requests approval for payment from the server of a payment company, such as a credit card company server 700 or a communication company/gift card company/bonus point company server 710, and which transmits the results of the approval to the mobile terminal 100 or the member store terminal 200. Furthermore, the corresponding server performs a function of transmitting the payment location (or the member store ID information or the member store object ID information), generated by the mobile terminal 100, and the measurement information about a wireless communication infrastructure to the LBS server 610.

The wireless communication infrastructure 500 is a base station or an AP around the mobile terminal 100, and the mobile terminal 100 obtains various types of measurement information (an ID, a Media Access Control (MAC) Address, a Received Signal Strength Indicator (RSSI), Real Time Text (RTT), or AoA) via passive or active communication.

When the mobile terminal 100 can provide the payment location, the LBS server 610 receives the payment location and the measurement information about a wireless communication infrastructure from the mobile payment company DB and server 400, generates the location of the wireless communication infrastructure, and stores the location of the wireless communication infrastructure in the location DB 620. Meanwhile, when the mobile terminal 100 cannot provide the payment location, the LBS server 610 calculates the corresponding payment location by comparing the received member store ID information or the member store object ID information with information stored in a map DB 630 which includes member store information. Thereafter, the LBS server 610 generates the location of the wireless communication infrastructure using the calculated payment location and measurement information about the wireless communication infrastructure, and stores the location of the wireless communication infrastructure in the location DB 620. Furthermore, the LBS server 610 generates additional information, that is, the payment location-based information (for example, a discount coupon or an advertisement). based on the payment location (or the member store ID information or the member store object ID information), and provides the additional information to the mobile terminal 100.

Meanwhile, the LBS server 610, the wireless communication infrastructure location DB 620, and the map DB 630 are included in a location-based service apparatus 600 according to the present invention if necessary.

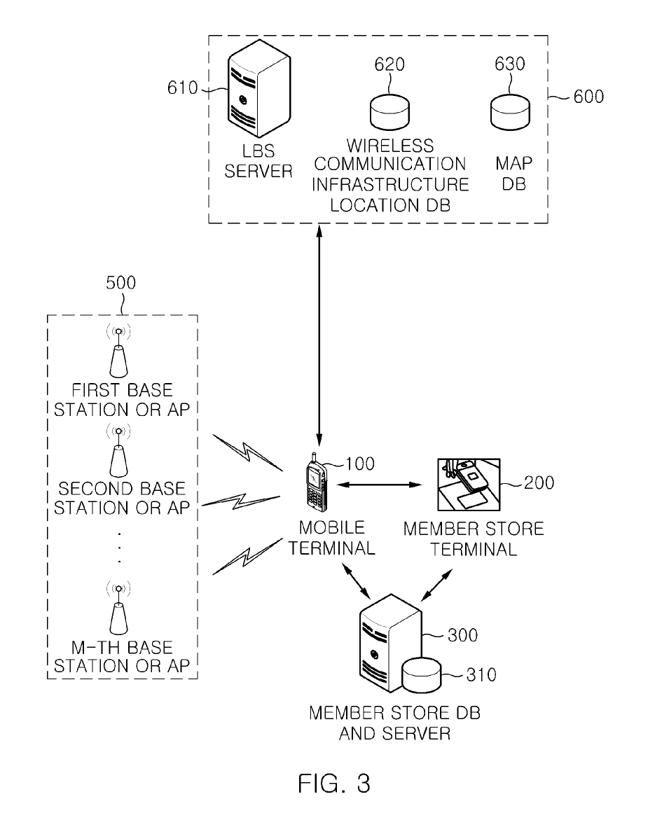

FIG. 3 is a block diagram illustrating a system 10 for constructing a location DB for mobile payment service-based infrastructures and providing a location-based service according to a second embodiment of the present invention. Unlike in the first embodiment, the mobile payment company DB and payment server 400 is not used in the second embodiment. Therefore, the descriptions of the components of the second embodiment are the same as those of the first embodiment except for the portion related to the mobile payment company DB and payment server 400.

For example, when the mobile terminal 100 can provide a payment location, the LBS server 610 receives the payment location and measurement information about a wireless communication infrastructure from the mobile terminal 100, generates the location of the wireless communication infrastructure, and stores the location of the wireless communication infrastructure in the location DB 620. Meanwhile, when the mobile terminal 100 cannot provide a payment location, the LBS server 610 calculates the corresponding payment location by comparing received member store ID information or member store object ID information with information stored in the map DB 630 which includes the member store information. Thereafter, the LBS server 610 generates the location of the wireless communication infrastructure using the calculated payment location and the measurement information about the wireless communication infrastructure, and stores the location of the wireless communication infrastructure in the location DB 620. Furthermore, the LBS server 610 generates additional information, that is, payment location-based information (for example, a discount coupon or an advertisement) based on the payment location (or the member store ID information or the member store object ID information), and provides the additional information to the mobile terminal 100.

Meanwhile, like in the first embodiment, the LBS server 610, the wireless communication infrastructure location DB 620, and the map DB 630 (if necessary) may be included in the location-based service apparatus according to the present invention.

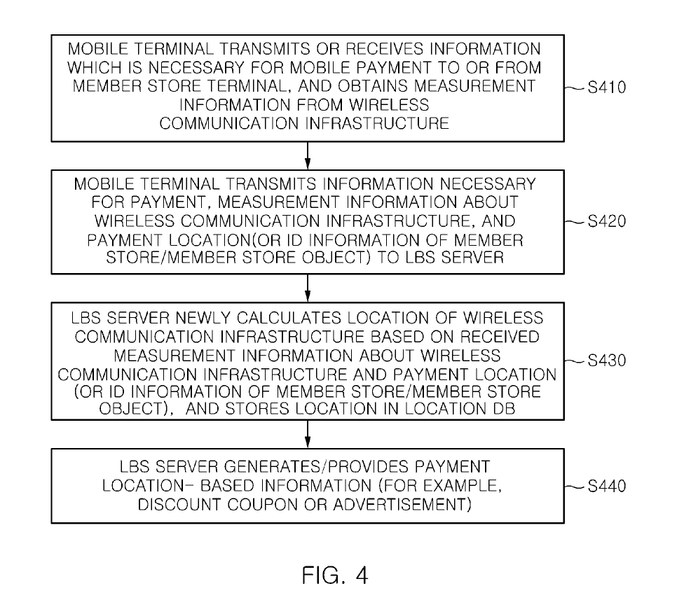

FIG. 4 is a flowchart illustrating a method of constructing a mobile payment service-based location DB and providing payment location-based information according to embodiments of the present invention.

At step S410, the mobile terminal 100 transmits or receives information (the total purchase amount, the member store information, etc.) which is required for mobile payment to or from the member store terminal 200, and transmits or receives measurement information (an MAC address, an ID, an RSSI, or RTT) about the wireless communication infrastructure (for example, base stations or APs) to or from a peripheral wireless communication infrastructure 500.

Thereafter, at step S420, the mobile terminal 100 transmits information required for payment, the measurement information about the wireless communication infrastructure, and a payment location (or member store ID information or member store object ID information) to the LBS server 610.

Thereafter, at step S430, the LBS server 610 newly calculates the location of the wireless communication infrastructure based on the received measurement information about the wireless communication infrastructure and the payment location (or the member store ID information or the member store object ID information), and stores the location in the location DB 620.

Finally, at step S440, if the user of the mobile terminal 100 desires, the LBS server 610 generates payment location-based information (for example, a discount coupon or an advertisement), and provides the payment location-based information to the mobile terminal 100.

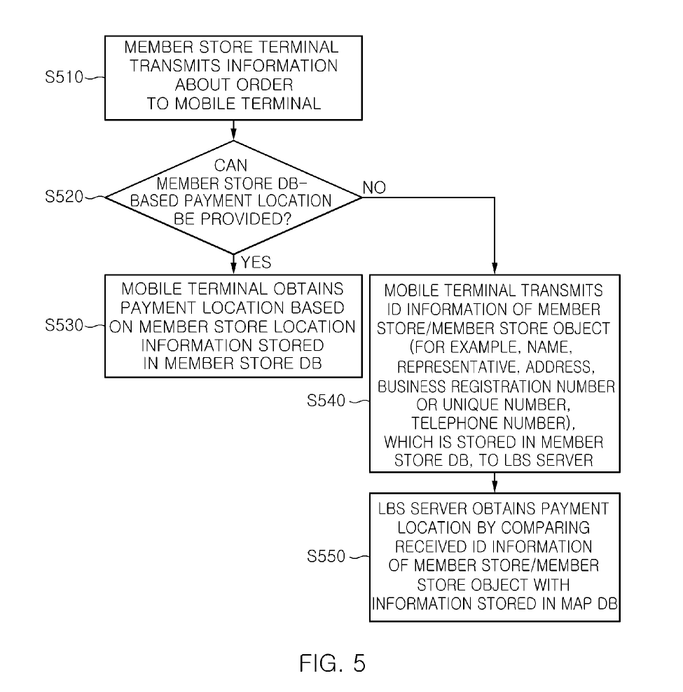

FIG. 5 is a flowchart illustrating a method of obtaining a mobile payment service-based payment location according to embodiments of the present invention.

At step S510, the member store terminal 200 transmits the information about an order (the total purchase amount and member store information) to the mobile terminal 100.

Thereafter, at step S520, if the mobile terminal 100 can access the member store DB 310 and member store location information stored in the member store DB 310 is sufficiently accurate to be used to estimate the location of the wireless communication infrastructure 500, the process proceeds to step S530. Otherwise (that is, the mobile terminal 100 cannot access the member store DB 310 or the member store location information stored in the member store DB 310 is not sufficiently accurate to be used to estimate the location of the wireless communication infrastructure even if the mobile terminal 100 can access the member store DB 310), the process proceeds to step S540.

At step S530, the mobile terminal 100 obtains the payment location based on the member store location information stored in the member store DB 310.

At step S540, the mobile terminal 100 transmits the member store ID information or the member store object ID information (for example, a name, the name of a representative, an address, a business registration number or a unique number, and a telephone number), which is stored in the member store DB 310, to the LBS server 610.

Thereafter, at step S550, the LBS server 610 estimates a member store location by comparing the received member store ID information or the member store object ID information with information stored in the map DB 630 which includes the corresponding member store information, and obtains a payment location based on the estimation.

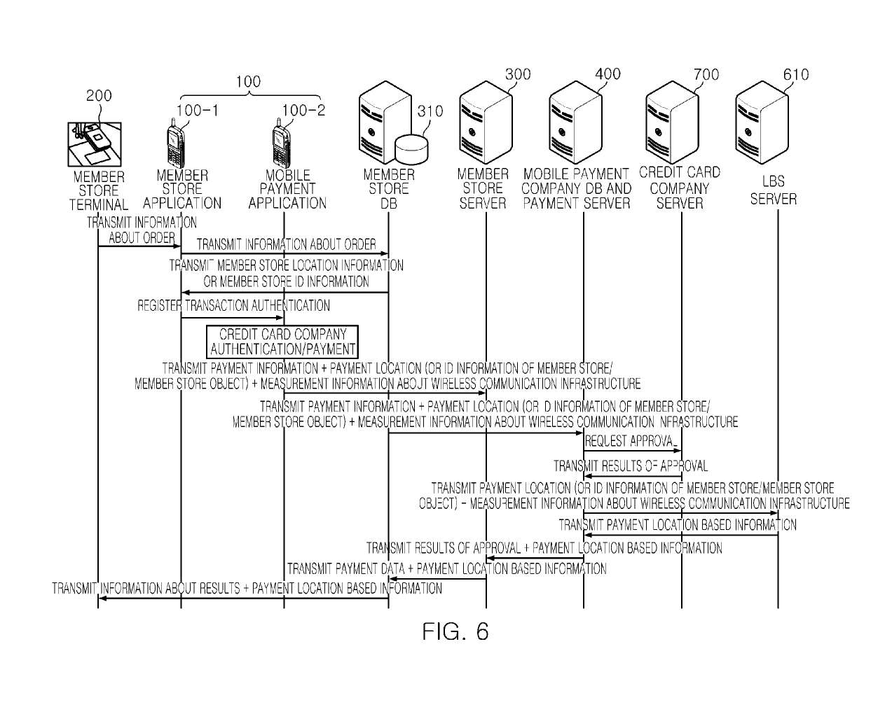

FIG. 6 is a view illustrating the procedure of the method of constructing a location DB for mobile payment service-based infrastructures and providing a location-based service in the case where the credit card company server 700 of the first embodiment is involved. FIG. 6 particularly illustrates the procedure of credit card-based mobile payment in a smart phone online VAN environment.

The member store terminal 200 transmits the information about the order to the member store application 100-1 of the mobile terminal 100. The member store application 100-1 transmits the received information about the order to the member store DB 310 such that the information about the order is stored in the member store DB 310, and obtains member store location information (or the member store ID information or the member store object ID information) stored in the member store DB 310.

A mobile payment application 100-2 is additionally executed to enable a credit card company to perform authentication/payment. Thereafter, the mobile payment application 100-2 transmits the payment information, the payment location (or the member store ID information or the member store object ID information) and the measurement information about the wireless communication infrastructure to the mobile payment company DB and payment server 400 via the member store server 300.

Thereafter, the mobile payment company DB and payment server 400 requests approval from the credit card company server 700, and receives the results of the approval. Furthermore, the mobile payment company DB and payment server 400 transmits the received payment location (or the member store ID information or the member store object ID information) and the measurement information about the wireless communication infrastructure to the LBS server 610 such that the payment location and the measurement information about the wireless communication infrastructure are used to construct the wireless communication infrastructure location DB 620.

Moreover, when the user of the mobile terminal makes a request, the LBS server 610 generates the payment location-based information (for example, a discount coupon or an advertisement) and transmits the payment location-based information to the mobile payment company DB and payment server 400.

Finally, the mobile payment company DB and payment server 400 transmits the results of the approval and the payment location-based information to the member store application 100-1 of the mobile terminal 100 via the member store server 300 and the member store DB 310.

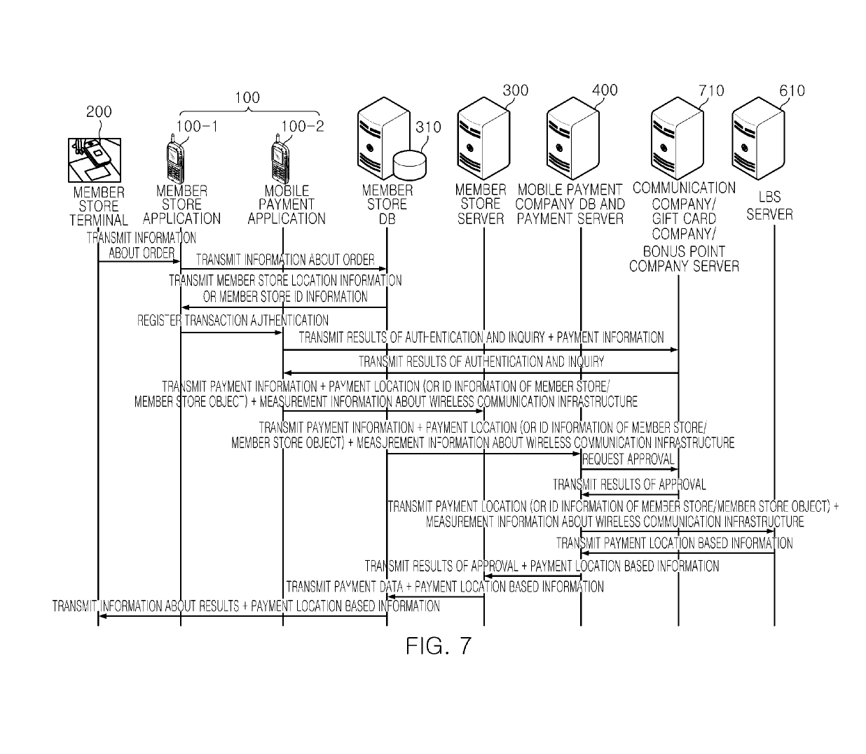

FIG. 7 is a diagram illustrating the procedure of the method of constructing a location DB for mobile payment service-based infrastructures and providing a location-based service in the case where the communication company/gift card company/bonus point company server 710 of the first embodiment is involved. FIG. 7 particularly illustrates the procedure of mobile phone/gift card/bonus point-based mobile payment in a smart phone online VAN environment.

The member store terminal 200 transmits the information about the order to the member store application 100-1 of the mobile terminal 100. The member store application 100-1 transmits the received information about the order to the member store DB 310, stores the information about the order, and then obtains member store location information (or member store ID information or member store object ID information) stored in the member store DB 310.

The mobile payment application 100-2 is additionally executed to enable the credit card company to perform approval/payment. The mobile payment application 100-2 requests authentication and inquiry from the communication company/gift card company/bonus point company server 710, and receives the results of the request. Furthermore, the mobile payment application 100-2 transmits payment information, a payment location (or member store ID information or member store object ID information), and the measurement information about a wireless communication infrastructure to the mobile payment company DB and payment server 400 via the member store server 300.

Thereafter, the mobile payment company DB and payment server 400 requests approval from the communication company/gift card company/bonus point company server 710, and receives the results of the approval. Furthermore, the mobile payment company DB and payment server 400 transmits the received payment location (or the member store ID information or the member store object ID information) and the measurement information about the wireless communication infrastructure to the LBS server 610 such that the payment location and the measurement information about the wireless communication infrastructure are used to construct the wireless communication infrastructure location DB 620.

Moreover, when the mobile terminal user makes a request, the LBS server 610 generates the payment location-based information, and transmits the payment location-based information to the mobile payment company DB and payment server 400.

Finally, the mobile payment company DB and payment server 400 transmits the results of the approval and the payment location-based information to the member store application 100-1 of the mobile terminal 100 via the member store server 300 and the member store DB 310.

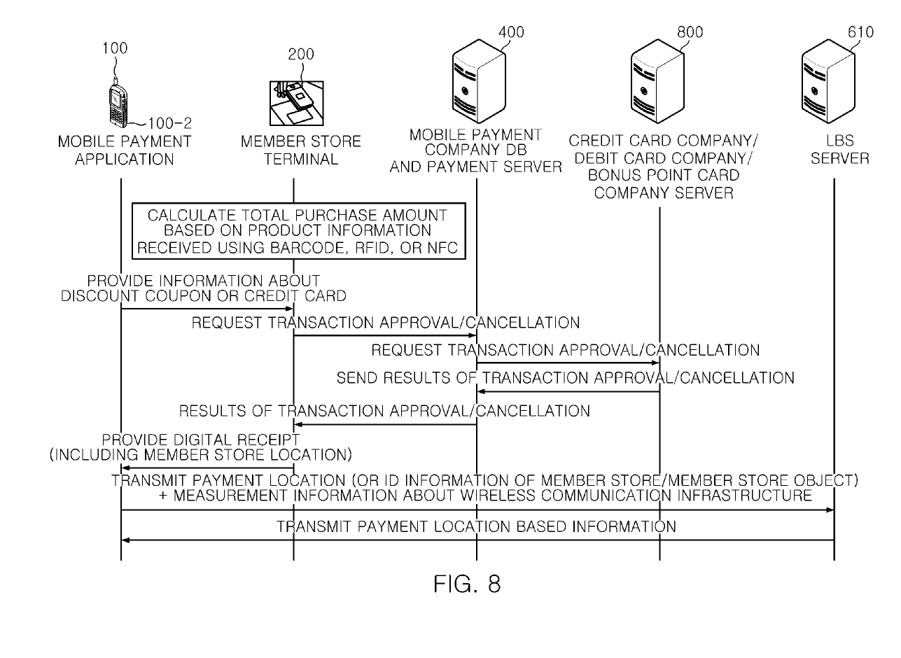

FIG. 8 is a diagram illustrating the procedure of the method of constructing a location DB for mobile payment service-based infrastructures and providing a location-based service according to a third embodiment. FIG. 8 particularly illustrates an embodiment of credit card/debit card/point card-based mobile payment in a smart phone online VAN environment.

The member store terminal 200 calculates the total purchase amount based on product information received using a barcode, RFID or NFC. The mobile application 100-2 of the mobile terminal is executed to make a mobile payment. The mobile terminal 100 communicates with the member store terminal 200 via a wired or wireless connection, and transmits information about a discount coupon or information about a credit card to the member store terminal 200.

The member store terminal 200 requests approval for a transaction/the cancellation of a transaction from the credit card company/debit card company/point card company server 800 and then receives a response, via the mobile payment company DB and payment server 400, based on the received information about a discount coupon or information about a credit card. Here, if the payment location can be determined based on the member store location information included in a digital receipt, a payment location and measurement information about a wireless communication infrastructure are transmitted to the LBS server 610. If the payment location cannot be determined based on the corresponding information, member store ID information or member store object ID information included in the digital receipt is obtained and is then transmitted to the LBS server 610 along with the measurement information about the wireless communication infrastructure. The member store ID information or the member store object ID information included in the digital receipt, and the measurement information about a wireless communication infrastructure are compared with information stored in the map DB 630, so that the payment location is obtained. Finally, the LBS server 610 can provide the payment location-based information to the mobile terminal 100.

As described above, the present invention provides the method of constructing a location DB for mobile payment service-based infrastructures and providing a location-based service, thereby collecting reference locations and measurement information about wireless communication infrastructures, which are necessary to construct a wireless communication infrastructure location DB, from a plurality of mobile terminal users who use a mobile payment service.

In particular, member store location information stored in the member store DB is used in an indoor environment in which a GPS-based reference location cannot be provided, or a reference location is automatically obtained through comparison performed on information stored in the map DB, thereby omitting the procedure for obtaining an additional reference location.

Furthermore, according to the present invention, mobile terminal users who are distributed throughout a wide area provide information which is necessary to construct location DB for wireless communication infrastructures to the LBS server in real time, thereby constructing the location DB while minimizing the collection costs compared to a collection-dedicated vehicle-based collection method.

Although the preferred embodiments of the present invention have been disclosed for illustrative purposes, those skilled in the art will appreciate that various modifications, additions, and substitutions are possible, without departing from the scope or spirit of the invention as disclosed in the accompanying claims.

What is claimed is:

1. An apparatus for providing a location-based service, comprising:
a location-based service server for, when a mobile payment service is performed for a member store terminal using a mobile terminal which receives information about a location of a member store from the member store terminal or a member store DB and which also receives measurement information about a wireless communication infrastructure from the wireless communication infrastructure, receiving the measurement information about the wireless communication infrastructure and the information about the location of the member store from the mobile terminal, and generating information about a location of the wireless communication infrastructure using the received measurement information about the wireless communication infrastructure and the information about the location of the member store; and
a wireless communication infrastructure location DB for storing the generated information about the location of the wireless communication infrastructure.

2. The apparatus as set forth in claim 1, wherein the location-based service server receives the measurement information about the wireless communication infrastructure and the information about the location of the member store from the mobile terminal via a DB and payment server of a mobile payment company.

3. The apparatus as set forth in claim 2, wherein the DB and payment server of the mobile payment company communicates with a server of a credit card company, a debit card company, a communication company, a gift card company, or a bonus point company.

4. The apparatus as set forth in claim 3, wherein the information about the location of the member store comprises member store ID information or member store object ID information stored in the DB of the member store.

5. The apparatus as set forth in claim 3, wherein, if the information about the location of the member store is not sufficiently accurate to be used to estimate the information about the location of the wireless communication infrastructure, the location-based service server receives the member store ID information or the member store object ID information from the user mobile terminal

6. The apparatus as set forth in claim 5, further comprising a map DB;
wherein the location-based service server calculates the information about the location of the member store by comparing the member store ID information or the member store object ID information with information stored in the map DB.

7. A method of providing a location-based service using a location-based service providing apparatus, the method comprising:
receiving measurement information about a wireless communication infrastructure and information about a location of a member store from a mobile terminal, the mobile terminal receiving the information about the location of the member store from a member store terminal or a DB of the member store, the mobile terminal receiving the measurement information about the wireless communication infrastructure from the wireless communication infrastructure, the member store terminal used for a mobile payment service;
generating information about a location of the wireless communication infrastructure using the received measurement information about the wireless communication infrastructure and the information about the location of the member store; and
storing the generated information about the location of the wireless communication infrastructure in a wireless communication infrastructure location DB.

8. The method as set forth in claim 7, wherein the receiving the information about the location of the member store comprises receiving the measurement information about the wireless communication infrastructure and the information about the location of the member store from the mobile terminal via a DB and payment server of a mobile payment company.

9. The method as set forth in claim 8, wherein the DB and payment server of the mobile payment company communicates with a server of a credit card company, a debit card company, a communication company, a gift card company, or a bonus point company.

10. The method as set forth in claim 9, wherein the information about the location of the member store comprises member store ID information or member store object ID information stored in the DB of the member store.

11. The method as set forth in claim 9, further comprising, when the information about the location of the member store is not sufficiently accurate to be used to estimate the location information of the wireless communication infrastructure, receiving the member store ID information or the member store object ID information from the user mobile terminal.

12. The method as set forth in claim 11, further comprising:
providing a map DB; and
calculating the information about the location of the member store by comparing the member store ID information or the member store object ID information with information stored in the map DB.
